(19) United States
(12) Patent Application Publication
(10) Pub. No.: US 2005/0240916 A1
(43) Pub. Date: Oct. 27, 2005

(54) SYSTEM AND METHOD FOR DISTRIBUTED PROJECT OUTSOURCING

(76) Inventor: Barry B. Sandrew, San Diego, CA (US)

Correspondence Address: DALINA LAW GROUP, P.C., 7910 IVANHOE AVE. #325, LA JOLLA, CA, 92037, US

(21) Appl. No.: 10/709,275

(22) Filed: Apr. 26, 2004

(51) Int. Cl. G06F 9/45

(52) U.S. Cl. 717/154

(57) ABSTRACT

Embodiments of the invention provide a system and method for distributed projects comprising computer systems and employing outsourced labor to be initiated, worked and completed. A distributed project that has been divided into pieces may be worked by disparate groups of workers. This is accomplished by copying data to each distributed work site. The data is then worked with by the remote workers. Once the data is at the remote site both local and remote workers can divide and conquer the task at hand by further subdividing the project tasks that are worked on by each group of workers. Embodiments of the invention may transfer operations between sites instead of raw output data so that each site's work efforts can be added to the work product with minimal bandwidth. In at least one embodiment of the invention, the labor may be performed primarily by at least one site with at least one other site performing quality assurance primarily.

### BACKGROUND OF INVENTION

1. Field of the Invention

Embodiments of the invention described herein pertain to the field of computer systems. More particularly, these embodiments are directed to computer systems configured to enable disparate groups of workers spread across a plurality of work sites to successfully coordinate efforts made towards the completion of a common project.

2. Description of the Related Art

It is common in the technology sector, as well as in other areas of the business community, for companies to attempt to increase profits by directly or indirectly “outsourcing” certain projects to areas of the world that have an abundant supply of cost effective labor. However, despite having the benefit of more cost effective labor many outsourcing projects fail to deliver the promised cost savings and produce an inferior result.

One of the main problems encountered in outsourcing has more to do with the management of labor than the skills of the labor itself. Successfully managed projects typically include a defined set of project requirements, project management, project control, configuration management and quality control. These activities and other more sophisticated elements of project management are often overlooked in an effort to cut costs. This is known as “throw over the wall” project management whereby a project is initiated and the only time that the project work product is assessed is at project completion time. When a project is managed in this way there is a limit to the amount of cost benefit gained with current architectures and processes since the work product often does not meet the expectations of the project whether the expectations are explicitly defined or not. Simply put there is no control of the project and so the project output solves the wrong problem. With no configuration management there are no intermediate points to which the project can be reset and worked from again. Inferior project management breeds inferior work product. With no way to train distantly located workers, there is little hope that many outsourced projects can be performed to the promised level.

The security of an outsourced project, including the finished work product, is another aspect of project management that current systems do not satisfactorily address. When a project is outsourced to a distant location, data and/or materials required to perform and monitor the project are transmitted between the outsourced location and the in-house management for the project. When projects are managed this way a large amount of network bandwidth is required to effectively communicate the necessary information between the two separate locations. Since such bandwidth is not necessarily available in all parts of the world this limits the number of locations where it is feasible to outsource projects.

In summary, current systems lack an efficient and effective methodology for allowing distributed labor to be applied to a computer based project in a bandwidth sensitive and rapid feedback environment. Hence, many outsourcing projects currently fail to deliver the promised cost benefits since many of the projects fail to meet expectations in quality. There is a need for a system that overcomes the problems mentioned herein in a cost effective and reliable manner.

### SUMMARY OF INVENTION

Embodiments of the invention are directed to a system and method for managing outsourced labor in a way that successfully achieves desired reductions in the overall cost of a project. One or more of the systems embodying the invention employs a divide and conquer strategy to maximize the benefits of outsourcing. For instance, one or more embodiments of the invention adopt an approach that intelligently partitions project tasks and project data in a way that accounts for the geographical constraints of a project, but still maintains project control and quality assurance. This maximizes the effectively of the outsourced labor by strategically breaking out labor intensive portions of the project and providing an infrastructure where work product is generated in a distributed and bandwidth sensitive manner.

Providing project overseers with rapid feedback and control yields a higher quality result and the control required to correct product output while minimizing misdirected effort and rejected work product. Configuration management and redundant configuration management capabilities allow for industrial strength iterative development by allowing tasks to be replayed or reset to a given point in time so that rework efforts are minimized and errors can be understood and avoided in the future. Embodiments of the invention may use metrics of the work product including statistical analysis of the work product to fine tune the work site interconnection topology and refine the tasks performed at each work site. These metrics are also useful for purposes of training or other activities designed to increase the skill of the workers and increase productivity.

To transmit project operations (e.g., the creation, updates and deletions to the project data), without transferring finished work product, one or more embodiments of the invention utilize star architectures, peer to peer, parallel and/or pipeline topologies.

These methods of transmitting project operations may take advantage of specialists that continually work a certain portion of a project and pass the operations applied to the data between sites in order for the other sites to apply those same operations without requiring the passing of the entire finished product. This approach is a different method than is used, for example, in an automobile assembly line wherein the entire work product must pass between work sites and has operations performed on it along the way. Although embodiments of the invention allow for dependent intermediate work product operations and/or independent intermediate work product operations to flow between work sites, the intermediate work product itself is not required to be transferred between work sites. Systems embodying one or more aspects of the invention may already have the raw project data at each work site, or a sub-portion thereof that operations are applied to with the operations passed between work sites instead of the entire work product. For instance, embodiments of the invention allow for iterative work cycles in addition to construct-at-once and pipeline produced work products. Using iterative work cycles it is possible to implement a quality assurance process that requires a given work site to polish its generated operations or tasks performed in a recursive methodology until the work site achieves certain statistical measures. For example, instead of sending the whole finished product a work site may send a simple command to re-iterate in light of the total operations received on a particular work piece with parameters that specify which portions of the work piece need more specific attention. When the iterated operations flow through the various work sites, it is possible to produce the finished work product by combining all of the operations on all of the work pieces. This combination step may involve reordering the received messages comprising operations and parameters into the desired precedence or time order.

By dividing a distributed project into separate tasks, embodiments of the invention enable disparate groups of workers at a plurality of work sites to work together towards a common set of goals (e.g., project completion). For instance, embodiments of the invention may accomplish this and other project milestones by copying to each work site a project data file or subset thereof that contains work pieces to be handled at each distributed work site. For large project data files the system may physically transfer files to the work sites for bandwidth and security reasons. Such physical transfer may occur using any mechanism for transporting physical data between sites. Some examples of the types of medium used for accomplishing physical transfer include, but are not limited to, physically sending disk array or tapes or disc archives. Once the data is at the remote site both local and remote workers can work with the project data file. Embodiments of the invention may utilize stamps such as time stamps, work site identifiers, serial numbers or any other identification methodology on the user interactions so that the work efforts of disparate groups may be combined when working on a particular work piece. Certain types of work pieces may comprise a stamp per work piece such as a serial number, unique identifier, or time stamp such as for example SMPTE time code. By associating the operations/interactions with stamps on the work piece, operations may be transferred and performed at different locations on the same work piece as identified by the stamp.

Embodiments of the invention that allow for overlap of work on the same work pieces or on separate parts of the project data file at the same time comprise parallel embodiments. Another embodiment of the invention partitions the work portions of the data by copying only the portion of the data that a given work group is to work on to that group. This may include several related work pieces. The work may be subdivided further within each work group so that work on project tasks is performed by each group of workers at the correct granularity. Embodiments of the invention may transfer operations applied to the data between sites instead of raw output data so that each site's work efforts may be applied to the finished work product with minimal bandwidth requirements.

By only transferring operations and parameters or aggregations thereof, the system achieves the ability to outsource whole projects to work sites in areas with limited network bandwidth. Before initiating work at a particular work site, embodiments of the invention allow operations from another work site to be applied to the project data file. For example, this occurs when a given work piece has an operation performed on it that another work site must obtain and update the project data file before performing specific additional operations which depend on the work performed at the originating work site. Embodiments comprising work sites dependent upon the operations generated at another work site are termed “dependent”. If the sites are all working at the same time, albeit on different parts of the project, the work sites are said to be “pipelined”. Parallel work flows also involve work sites that work on a different part of the project at the same time, but do not have dependent work pieces and are asynchronous.

In at least one embodiment of the invention, the labor is performed primarily by at least one work site with at least one other work site primarily performing quality assurance. The work product may be updated in real-time and embodiments of the invention that are pipeline, parallel or tutorial based may utilize real-time updating of each work product on each computer system. Embodiments of the invention utilize rapid quality assurance to maximize the effectivity of the remote workers and in turn the increase the overall quality of the finished work product and increase the cost effectiveness of the outsourcing endeavor. Embodiments of the invention may also utilize batch updates at scheduled or irregular times, for example on the completion of sub-tasks or project milestones, in order to update the work product at the original work site or at other distributed work sites.

For example, embodiments of the invention have applications in movie restoration or preservation projects. Given a work input or project data file comprising a digitized movie and finished work product comprising a restored movie, a movie to be preserved may be digitized into TIF images and copied to at least one work site. A digital scan of a frame of a move at high resolution yields 12 Megabytes per frame and with 24 frames per second for a two hour movie for example, the resulting project data file is 2.2 Terabytes or 17,394,617,548,800 bits. Using a 10 Megabits/second data rate for transferring a file of this size would take 20 days to send to a remote work site. At 100 Megabits/second a file this size would take over 2 days to send. The chances of the data transfer completing without data loss in third world areas is not high. Since some third world countries comprise connection speeds on the order to 50 Kilobits/second the time required to transfer the file can greatly exceed the amount of time to actually perform the project in this example, over a decade. With data sets this large, it is actually easier to physically send a disk array, CD/DVD archive or tape set to a remote work site as opposed to electronically transfer the data. The effective bandwidth of a plane carrying a disk array may be higher than a third world electronic infrastructure depending upon the location of the remote work site and the amount of data physically transferred.

Once the project data file or a portion thereof is transferred to a work site, the project related tasks may be completed using the project data file. The operations or user interactions with the project data file or subset thereof are recorded and stamped and sent to another work site. In the case of rapid feedback embodiments or tutorial based projects the operations and parameters are immediately transferred to the site where feedback is to be originated so that a supervisor can readily send feedback to the work site where the operation originated from. For other types of projects the operations may be batch transferred on a schedule or at task based milestones or manually transferred at the direction of the user. Systems embodying the invention may, for instance, enable operations such as scratch removal, color correction, microphone removal or other production or post production operations such as sound filtering.

Once the work-input is copied to a second work site, the process of working with the data may begin. The data may be a subset of the total data or the entire data set. The work to be performed on the project may be subdivided by the initial data sent, or may be further subdivided at the distributed work site. The system may send task descriptions utilized in transforming the data as part of the project data file or provide those to an organization a priori. The system may transfer task descriptions separately from the project data file or the task descriptions may be known to a work site. For large project data files it is possible to utilize either method. With the task descriptions defined for the project data at the second site, the operations used in transforming the data may be sent to the first work site and/or other distributed sites in order to update the other local project data intermediate work output. Since the operations and parameters are sent to the other work sites, they may be digitally signed and sent in the clear since without the original project data file there is no possibility of producing the finished work product even if the operations are intercepted. For large project data files physically transferred to an outsourcing work site, there is no possibility of recreating the finished product by intercepting the operations on the set of work pieces in a project data file.

For example, in a movie colorization application, operations which operate on a given frame at a given SMPTE time may be transferred either in real-time or in batch mode at a regular or irregular interval to at least one other site. Instead of sending the finished work product of each frame which would be 12 Megabytes in size regardless of the number of operations performed on the frame, the operations applied to that frame are sent to the remote sites in order to show where on the frame the operation was applied and what parameters were used in the operation. For example 50 Kilobytes of operations or parameters such as color settings and masks may be sent per frame instead of 12 Megabytes of one worksite's efforts on a given frame. This provides a massive savings in bandwidth since the operation may easily be duplicated on the work piece at the remote site to generate the intermediate resulting frame on the remote site and the operations with parameters may in other cases may be on the order of kilobytes for entire scene comprising a few hundred frames, while the output images will be on the order of gigabytes for the scene. In this way, the work output product does not have to be sent back at all, merely the operations on the data may be transferred. Since the output data images do not need to be sent back the output takes 2.4 days less at 100 Megabits/second or 24 days less at 10 Megabits/second since transferring several kilobytes of operations and parameters may take on the order of seconds or a few minutes for example with slow communications links.

When operations on various work sites are applied to a given project data file or intermediate work piece within that file, the stamps of the various operations applied to the data may be utilized in order to apply the operations in the proper order. Alternatively a work site identifier in a known work product flow can be utilized in order apply operations from a given work site on a give work piece in a given order. Another embodiment of the invention may utilize both methods of stamping and work site identifier. Any other means of determining the order in which the operations would be applied may be utilized, such as by task identifier, employee ID lookup tables or any other means.

Although some work pieces allow for independent work to be applied to them, some work pieces or portions of work pieces may not allow for independent work and may detect collisions in the work efforts of two separate work sites. For example, if one work site was to apply a given operation at a given area of a given work piece and this interfered or for example overlapped in two-dimensional space in the case of an image edit operation with another operation from another work site, then a collision would be said to occur. This could also occur in text editing outsourcing where two workers edited the same portion of text. If the operations are mutually exclusive, then they may not interfere with one another for example even if they do overlap in geographical space in the image editing example or comprised orthogonal operations such as text color for a paragraph and adding text to the paragraph as another operation. These latter operations although overlapping in some way do not give rise to a collision. If the operations are non-linear when applied and the order of the operations has not been specified before the application of the operations and the order that the operations are applied in creates two different intermediate work products then a collision may be flagged for a quality assurance worker to investigate. In some situations this may not even be required since for example in the case of movie colorization if a collision occurs on one frame within a screen, this may not even be noticeable to a person watching the movie and so may be optionally ignored. An outsourcing task comprising the programming of a FPGA chip for example wherein one work site was responsible for designing one set of functions into a portion of the FPGA and another work site was responsible for designing a different set of functions into a different portion of the FPGA would not interfere with each other so long as all interfaces were maintained as specified and each work site did not program a portion of the chip that they were not responsible for or use a combined amount of resources greater than the chip possessed in which case a collision may occur.

In order to increase the efficiency of the work sites and increase the quality of the work output corrective actions may be relayed to the work sites either in real-time or after batch uploads of the operations from a work site and quality assurance has been performed on the recreated work pieces. In order for managed activities to effectively produce the desired results, corrective actions must be taken when the results deviate from the plan. Projects may also use metrics in order to calculate the efficiency or quality of various workers and/or work sites and by quantitatively managing the process using statistical control taking into account the metrics derived from the various operations and intermediate and final work products the cost effectiveness of the outsourcing operation may be further increased.

An embodiment of the invention provided with a work input comprising a digitized movie and a work-output comprising a colorized movie may perform the desired work by copying the digitized movie to a distributed work site and performing the colorization operations on the movie while sending the operations to at least one other distributed site where the output is generated locally at each work site. For example, colorizing an image or movie in a realistic manner may comprise breaking a movie into like scenes, designating key frames, creation of color mapping functions for objects in related scenes, masking objects and selecting colors for insertion into the masked objects of each image, in addition further perturbation of colors injected into the masks to add a further element of reality may also be performed. Embodiments of the invention may comprise a coloring application that allows colors to be selected for given luminance values within defined mask regions in an image. With predefined colors set for a key frame in the scene to be colorized as designated at one work site, the distributed work task may be for example to select which of the color transfer functions to apply to a given object and to ensure that a mask covers an object over the entire scene at a second work site. Although these two distinct operations may be applied at one work site, the more labor intensive tasks and associated operations may be slated for an outsourcing work site employing cheaper labor. In addition, the operations and parameters generated at a work site, for example the masks and the color transfer function identifiers applied to those masks, may be sent to at least one distributed work site for quality assurance or for simply completing the task. Since the intermediate work product can be reconstructed on another site with the operations and the original data that already exists on the remote site, the intermediate output frame is not required to be transferred, thereby resulting in a decrease in transfer time and therefore a decrease in the latency of the between work sites.

An embodiment of the invention used for rotoscoping for example may involve a work site that performs outlining of moving objects or characters in a scene. The operations in masking and outlining the objects and their associated parameters are then passed to another work site that may be in charge of inserting the masked characters (calculated from the mask operations transferred between sites when applied to the designated frames for example) on an entirely different background that only the second work site possesses. Rotoscoping may be very labor intensive and use of skilled yet cheap labor in this area is very beneficial as long as quality can be controlled throughout the project in a time sensitive manner to minimize rework and wasted labor.

In terms of generating the final work product, the operations may be copied to a master work site that is involved in constructing the finished work product, or the operations may be sent to a peer or even all other work sites in the system for a measure of redundancy. This provides a measure of system assurance as well since if one computer or even an entire site is damaged, the entire work product may be generated from a second work site. As the operations are sent between various sites they may be stored under configuration management control so that they may be recalled and updated later and so that different versions of the work product may be produced to test various efforts performed on the various work pieces.

In one or more embodiments of the invention training is accomplished by remotely observing work performed at a remote site by observing the operations being performed at the local site and adjusting the operations and parameters and sending them back without sending the entire work piece. This rapid training methodology may allow a specialist to engage a number of work sites and improve the skills of the remote workers in real-time to ensure that the best possible work product is produced by the work site. Since the operations may be sent between a plurality of work sites, more than one site can participate in the work effort or training effort in real-time. Also, since the operations may be stored and replayed in time order later, the session can in effect be recorded and played back later at the speed at which it originally occurred or at a faster or slower speed, or even in reverse time order. The types of playback of operations performed on a work product may also comprise tests at various points for various workers so that they can gain the skill set required to perform the project tasks.

The security of the system is very high since only operations are sent, so intercepting the operations yields nothing since the interceptor does not possess the data. Also, by partitioning the work product to several sites, a theft of one sites entire work product may only yield a fraction of the total work product. With the redundant copying of data between sites, the compromised work site may not hinder the final work product produced.

### BRIEF DESCRIPTION OF DRAWINGS

FIG. 1 is an architectural overview of an embodiment of the invention showing the flow of operations with one dependent pipeline path and two independent work piece task flows.

FIG. 2 is an architectural overview of an embodiment of the invention showing the work pieces associated with a project data file.

FIG. 3 is an architectural overview of an embodiment of the invention showing the flow of operations employing redundant configuration management.

FIG. 4 is an architectural overview of an embodiment of the invention showing the flow of feedback for quality assurance.

FIG. 5 is a sequence diagram of an embodiment of the invention employing parallel and pipeline task flows with quality assurance feedback with distributed configuration management showing a collision.

### DETAILED DESCRIPTION

In the following description, numerous specific details are set forth to provide a more thorough description of the invention. It will be apparent, however, to artisans of ordinary skill in the relevant field of expertise, that embodiments of the invention may be practiced without these specific details. In other instances, well known features have not been described in detail so as not to obscure the invention. The claims, however, and the full scope of any equivalents are what define the metes and bounds of the invention.

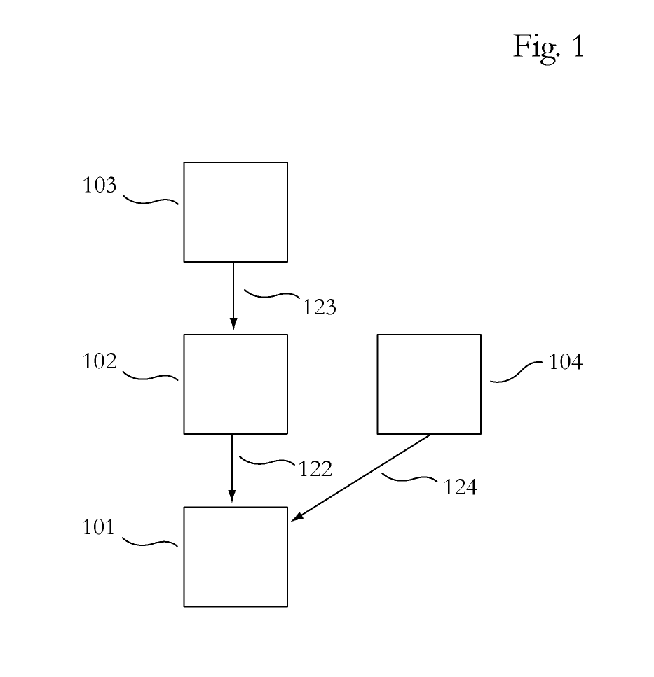

FIG. 1 is an architectural overview of an embodiment of the invention showing the flow of operations with one dependent pipeline path and two independent task flows. Work site 103 sends operations over link 123 to work site 102. Work site 102 further modifies the operations themselves or applies the operations generated at work site 103 on its local copies of the work pieces in order to finish work on the work piece copies that work site 102 also possesses. Since the operations performed at work site 102 are dependent upon the operations performed on the same data at work site 103 this flow of operations is said to be a dependent pipeline path. Note that this topology is but one example of a multitude of architecture layouts that may be constructed to solve the problem posed by a project. The output from site 102 therefore comprises the operations from work site 103 as originally created at work site 103 and/or as modified by work site 102 with the operations and parameters applied at work site 102 as well.

The output of work site 102 is sent over link 122 and the output of work site 104 is sent over link 124. In this embodiment the operations performed on the work pieces at work site 102 and 104 are independent and may be done in parallel. In this example, the data operated on may be the same work pieces and the operations performed at work site 104 may not collide with the operations performed on the same work piece copies at work site 102, or the work pieces may be different mutually exclusive work pieces comprising a subset of the project data file. In either case, after determining that operations at two work sites will not interfere or collide with one another, the work sites may be configured as parallel work sites that generate independent operations on the work pieces whether the work pieces comprise the same subset or not. The operations provided to work site 101 are ultimately combined or further modified by work site 101 to produce the finished work product. The capability of working on the same work pieces at different work sites at the same time and only passing the operations and parameters applied to the work pieces allows for parallel work flows that decrease the amount of time that a given project takes. This is not possible in the physical world, for example in an automobile factor where the physical work piece can only exist in one place at a time.

The topology of FIG. 1 is one possible example of a configuration set up to perform a particular set of tasks in a particular order. The number of work sites involved and the links between them may be customized for a given project. A Gantt chart comprising four elements wherein one task depends on another and the output of two of the tasks flowed into the final task may possibly lead to the topology so described.

In this embodiment of the invention work site 101 is a final assembly work site since work site 102 and work site 104 do not share or communicate their operations to each other in this configuration. If work site 102 and work site 104 were to share operations, then the final work product could be produced at either work site and in this case work site 101 could be involved with quality assurance alone by providing feedback to the various work sites as will be described herein.

As work site 101 gathers operations, the operations can be applied to the project data file as per the parameters associated with each operation from each work site. This makes for an “assembly point” factory which differs from the physical world requirement of an assembly line wherein the entire product itself must be passed through an assembly line with various components added/deleted/modified at each location along the line. In this example embodiment of the invention, operations alone are passed without passing the entire work product in order for at least one work site to be able to generate the finished work product at an assembly point. The advantages of this method is that lower requirements for bandwidth are needed on links 123, 122 and 124 and the lines of communication may use digital signatures if desired instead of complete encryption since knowing the operations would not allow someone to create the final work product since the work pieces may not be sent electronically due to low bandwidth links or security reasons. Work site 101 creates the final output by re-performing the operations from the various work sites in the proper order on the project data file comprising the work pieces used at the various work sites.

The operations generated at work sites 103 102 and 104 can be sent on links 123, 122 and 124 respectively when they are performed in a real-time configuration. The operations can also be sent at certain milestones, for example when a given desired operation has completed, or in a batch mode at scheduled intervals unassociated with the completion of operations. The operations can be sent in clear text, binary, XML or any other format and may be digitally signed to ensure that no changes or viruses have been introduced. Upon receiving the operations, each work site may place the received operations and the operations generated at the same work site under configuration management so that operations can be replayed on the project data file or work pieces and deleted or returned for re-work if the operations do not meet the quality assurance parameters in use.

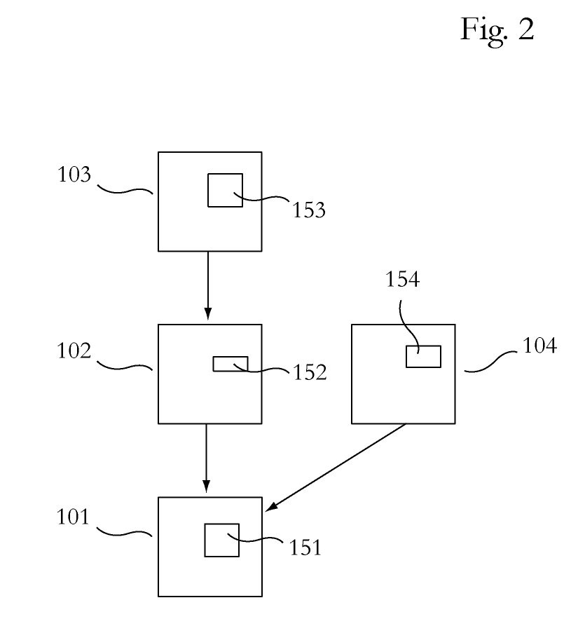

FIG. 2 shows project data file 151 comprising the entire set of work pieces to be operated on by the various work sites. The various work sites may obtain the project data file or a subset of the work pieces in the project data file in order to perform the tasks assigned to the given work site. For example, work site 103 is shown as having been given an entire copy of project data file 151 i.e., project data file 153 while work site 102 has been given a subset of project data file 151 i.e., work piece set 152. Work site 104 has been given a different subset of project data file 151 i.e., work piece 154. Operations generated on project data file 153 at work site 103 that are directed towards work pieces that do not exist in work piece set 152 may either be passed through to work site 101, or may be flagged as not capable of being worked on by work site 102. As some projects comprise very large project data files, it may be advantageous to physically transfer the project data file to the work site depending on the bandwidth of the link between the various sites and the size of the project data file. After the various work sites have obtained the project data file, they may operate on the work pieces in the project data file in a manner than generates operations and parameters which allow another work site to apply those same operations and parameters on copies of the work piece in order to produce an intermediate work output or final work product. Although this configuration shows one work site 101 as the assembly point, there may be more than one assembly point that produces a fraction or the whole final work product. For topologies that allow multiple work sites to create the final work product a level of redundancy is obtained that can greatly reduce the possibility of catastrophic data loss at one site. This level of redundant capabilities is easily achieved when the operations sent between the various sites are small, even if the final work product is extremely large.

The splitting of the project data file may take into account the various worker specializations at the various work sites. For example, work site 103 may comprise workers with low level skills generating operations on data that are labor intensive while work site 102 may comprise workers that use the brute force efforts of work site 102 to create a refined intermediate operations used to recreate the intermediate work product at work site 101 to combine with the operations generated by intermediate skill level work site 104. Using the same topology, work site 101 may comprise highly skilled workers that are capable of splitting the project data file into sets of work pieces that are destined for certain work sites that specialize in certain operations. In another scenario, work site 103 may comprise higher level skilled workers than work site 102 who use the refined operations generated by work site 103 in order to perform their lower skill tasks. In other scenarios, work sites 102 and 104 may each comprise a range of skill sets and the work pieces could be split accordingly. Various vertical and horizontal splits of the project data are possible with this architecture. The common feature among the various topologies is that the operations flow and the work pieces remain stationary.

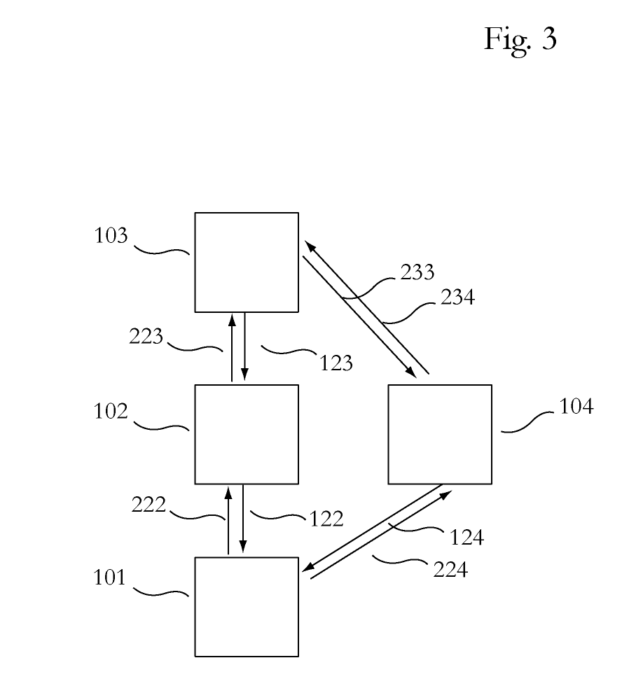

FIG. 3 shows that the operations can be copied to work sites other than to a work site that generates a final work product in order to provide a level of redundant configuration management. In this example, the amount of operations messages sent is double that of FIG. 1 since each work site has been assigned a second peer that the work site sends a copy of the operations generated at the work site. Since each work site sends operations to two other work sites in this scenario, work sites 103 and 104 communicate with each other where they did not do so in the topology shown in the architecture diagram of FIG. 1. Alternatively, work site 103 could also send operations to work site 101 and work site 104 could use work site 102 as its second peer, this is not shown for brevity.

Although it is possible to send a copy of every operation to all work sites, the amount of operations sent is roughly on the order to N*(N−1) instead of 2*N in the double peer architecture and when large numbers of work sites are involved, double redundancy usually provides adequate assurance. For example, when an operation is generated at work site 103, that operation is sent to work site 102, for further transformation or for applying to a work piece that is further operated on, over link 123. The same operation sent from work site 103 to work site 102 is sent to work site 104 over link 233 for redundant configuration management. When an operation at work site 104 is generated, it is sent to work site 103 over line 234 for redundant configuration management and to work site 101 over link 124, for further transformation or for applying to a work piece that is further operated on or for use in creating the final work product.

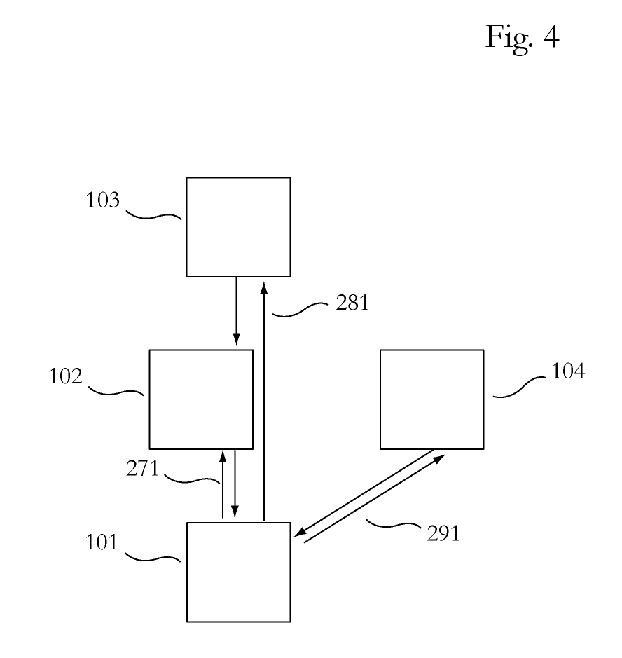

FIG. 4 shows the flow of feedback in an embodiment of the invention. Link 281 is used to send feedback from work site 101 to work site 103. Another link could exist between work site 102 and work site 103 but is not required if no quality assurance is performed at work site 102. Link 271 is used to send feedback to work site 102 and link 291 is used to send feedback to work site 104. Feedback may be in the form of modified operations, undo operation commands, backing out a date range of operations as per the configuration management capabilities of the system, or in the form of a video link or audio link that allows another worker to modify operations in order to conform to the teachings or quality assurance of the lead worker at work site 101. Any work site that receives operations may provide feedback to a work site that generates operations and in this way, quality assurance is greatly enhanced. In terms of outsourcing, the best cost effective results occur when feedback is provided during the project and not simply at the end of a project.

When operations are flowing through the links in real-time, it is possible to actually watch a remote worker work by applying the operations locally on a work piece without transferring the work piece itself. The feedback in this case can be over for example link 291 which could comprise a video, audio or electronic link. If an electronic link is used, then the operations can be modified by the lead worker at work site 101 which provides instant feedback to the worker at work site 104 for example. In this way it is possible to train a worker or show the worker how the work should be performed. Early correction of defects in work output can yield great overall cost savings in a project. Since embodiments of the invention allow for distributed project control at the level of a local project even if the work sites are distantly located, the work can be performed cheaper with acceptable quality and with the same feedback as would be obtained from a group of local workers.

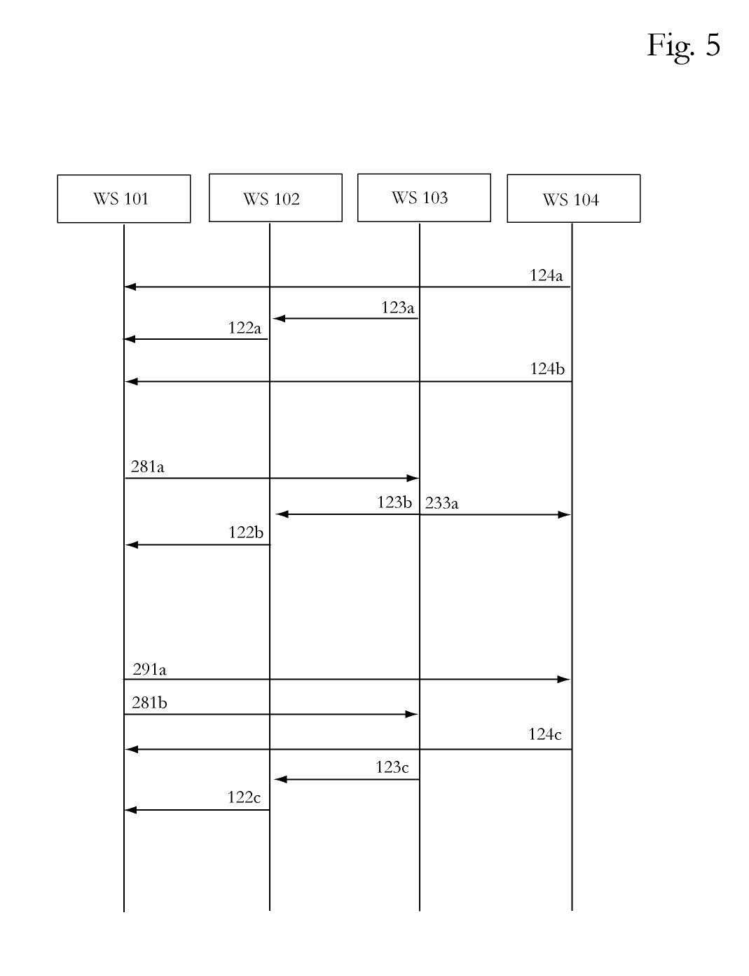

FIG. 5 shows a sequence diagram with work sites shown horizontally and time flowing down the page vertically with time increasing further down the written page. This figure shows an embodiment of the invention employing parallel and pipeline task flows with quality assurance feedback with distributed configuration management showing a collision recovery. Work site (WS) 104 sends an operation and associated parameters, or an aggregation thereof over as message 124. This message flows over link 124 as per FIG. 1. Work site 103 sends message 123a to work site 102 and work site 102 either transforms the operation(s) in message 123a or applies the operations to it's local work piece before performing its own operations and sending an aggregated combined block of operations from work site 103 and work site 102 as combined message 122a. Work site 104 then sends another message 124b to work site 101. Message 124b follows 124a in time order, however, the operations may have been originally generated in a different time order and may be the result of different updating mechanisms. Message 124a may have been sent first due to the fact that it was a higher priority operation or simply because the operation closed out a milestone while operation(s) in message 124b may have been scheduled for batch update to work site 101. Although message 124a is sent before message 124b, it may be applied in reverse order on work site 101 to place the order to operations back in correct time order or sequence number order.

Based on the operations received at work site 101, metrics can be garnered from the operations or on the modified project data file as modified by the received operations and parameters as applied to the local copy of the data in order to determine the quality of the work output from various sites, or at a lower granularity to a worker or worker specific task level. The metrics can be used in the quality process to further refine where work is relocated at the present or sent in the future. In this manner a built in optimization system that may also use statistical methods allows for optimal quality and cost effectiveness.

Continuing in the scenario, message 281a comprises a feedback message that may comprise video, audio and/or electronic message information further comprising operations to be corrected or modified along with various parameters required by the operations. Message 281a may actually be a combination of message sent over phone, cable, wireless or other systems or networks and each of the various components may utilize a different transmission path. Message 281a for example may be sent as a result of one or more of the operations received in message 122a that ultimately were stamped from work site 103. Message 281a therefore has the effect of ensuring that work site 103 and/or 102 re-perform the specified task which is then sent via message 123b and message 122b after work site 103 and work site 102 complete their respective tasks wherein the task that work site 102 performs is dependent on work site 103. Although not shown for brevity, a feedback message to work site 104 would result in an updated message comprising at least one operation and any required parameters back to work site 101 as well.

Message 233a is a copy of message 123b. Message 233a is sent to work site 104 for redundant configuration management purposes. All other messages in FIG. 5 may be redundantly sent to other peers, either in a doubly redundant or multiply redundant manner, however this is not shown for brevity. If all messages, namely 124a, 124b and 124c were copied and sent to various peers, then if work site 101 or 104 were unavailable or rendered inoperable or suffered catastrophic failure, then the final work product could be recreated by instructing the peers comprising the work output messages from work site 104 to send the messages to another work site that could be designated the final construction site. This capability gives the topology a dynamic recovery capability that can be configured at project startup to ensure that a project finishes regardless of any system or network errors that occur. This implies that work tasks may have to shift in case of failure of an entire work site and the backup designated work sites for given tasks may also be set up prior to or during the project.

Continuing further down the sequence diagram, if the operations applied to a given work piece in work site 101 were deemed to have resulted in a collision, meaning that the operations overlapped or interfered in some way with each other, then message 291a and 281b for example may be sent to work sites 104 and 103 respectively. If the operation could be limited to one or the other site then of course only one of messages 291a or 281b may be sent in order to minimize the rework required. If the collision was of such as nature that it was unobservable or unimportant then neither message 291a or 281b would be sent. Assuming that both work site 104 and work site 103 for example required collision control, messages 291a and 281b may specify what tasks would be required to be reperformed and the message may possibly contain other parameters listing either the reasons or the quantitative values to avoid in order to generate operations that would not collide with one another. If the operations can be altered in time by work site 101 in order to provide an acceptable solution to minimize the effects of the collision then again, messages 291a and 281b would not be sent. Given that messages 291a and 281b are sent to work sites 104 and 103 respectively, after the work sites performed their tasks again, then messages 124c and 123c would be transmitted. Upon received message 123c at work site 102, work site 102 would perform any required modifications to the operation or perhaps no operations at all if the specific operations were independent, and transmit the resulting operations and parameters as message 122c.

After receiving message 122c, assuming no further work is to be accomplished, work site 101 would aggregate all of the operations on all of the work pieces in the correct time order and if no further feedback or collisions were mandated, produce a final work product.

Embodiments of the invention may be utilized for all types of outsourcing efforts involving computer related projects including film industry and artistic project such as movie restoration, movie colorization, rotoscoping, movie post production, audio production and post production work. These types of projects have in common large data sets that are operated on by workers employing computers. Other types of outsourcing projects may also benefit greatly from the architecture described herein including engineering services, translation services, logic design, software construction and text editing wherein only the operations and parameters for a given document are sent across the various links. Operations may be sent in the clear and may comprise digital signatures without requiring total encryption since the finished work product could not be recreated by intercepting the operations only without already having the initial work input or project data file. Although these types of projects may work with less raw data than the previous class of projects, they nonetheless may benefit from the rapid feedback enabled quality assurance and redundant configuration management features enabled with embodiments of the invention. Any other type of project that can be split into portions that comprise manual labor that is computer oriented may benefit greatly through use of the architecture and methods described herein.

Thus embodiments of an invention directed to a System and Method for Distributed Project Outsourcing is exemplified herein to one of ordinary skill in the art. The claims, however, and the full scope of any equivalents are what define the metes and bounds of the invention.

1. In a computer system, a method for managing projects comprising:
copying a first project data file from a first work site to a second project data file at a second work site;
performing at least one operation at said second work site on said second project data file;
copying said at least one operation between said second work site and said first work site;
applying said at least one operation performed at said second work site to said first project data file at said first work site; and,
producing a finished work product at said first work site without copying said second data file to said first work site.

2. The method of claim 1 further comprising:
providing feedback to a second worker at said second work site from a first worker at said first work site.

3. The method of claim 2 wherein said providing feedback is accomplished in real-time.

4. The method of claim 2 wherein said providing feedback is accomplished in non-real time.

5. The method of claim 1 further comprising:
copying said at least one operation between said second work site and a third work site for redundant configuration management.

6. The method of claim 1 wherein said copying said at least one operation is accomplished in real time.

7. The method of claim 1 wherein said copying said at least one operation is accomplished in batch mode.

8. The method of claim 1 wherein said applying said at least one operation relies on a stamp associated with said at least one operation.

9. The method of claim 8 wherein said applying said at least one operation further comprises applying a first operation having a first stamp from said first work site and a second operation having a second stamp from said second work site to said first project data file at said first work site in an order based on said first stamp and said second stamp.

10. The method of claim 9 further comprising:
detecting a collision resulting from the application of said first operation and said second operation to a first portion of said first project data file.

11. The method of claim 1 further comprising:
generating metrics based on said at least one operation itself.

12. The method of claim 1 further comprising:
generating metrics based on an intermediate work piece produced by applying said at least one operation to said first project data file.

13. The method of claim 1 further wherein said copying said first data project file further comprises physically transferring said first data project file to said second work site and wherein said copying said at least one operation further comprises electronic transfer.

14. In a computer system, a method for performing distributed computer projects using labor outsourcing comprising:
copying a first project data file from a first work site to a second project data file at a second work site;
copying said first project data file from said first work site to a third project data file at a third work site;
performing a third at least one operation at said third work site on said third project data file;
copying said third at least one operation from said third work site to said second work site;
performing said third at least one operation at said second work site on said second project data file;
performing a second at least one operation at said second work site on said second project data file;
copying said third at least one operation and said second at least one operation from said second work site to said first work site;
applying said at third least one operation performed at said third work site and said second at least one operation performed at said second work site to said first project data file at said first work site; and,
producing a finished work product at said first work site without copying said third data project file or said second data project file to said first work site.

15. The method of claim 14 further comprising:
generating metrics based on said second at least one operation itself.

16. The method of claim 14 further comprising:
generating metrics based on an intermediate work piece produced by applying said at second least one operation to said first project data file.

17. The method of claim 14 further comprising:
generating metrics based on said third at least one operation itself.

18. The method of claim 14 further comprising:
generating metrics based on an intermediate work piece produced by applying said at third least one operation to said first project data file.

19. The method of claim 1 further comprising:
playing back said at least one operation performed at said second work site at said first work site.

20. The method of claim 19 wherein said playing back said at least one operation occurs at a rate different from the rate observed in a plurality of stamps in said at least one operation.

21. A system for performing distributed computer projects using labor outsourcing comprising:
means for copying a first project data file from a first work site to a second project data file at a second work site;
means for performing at least one operation at said second work site on said second project data file;
means for copying said at least one operation between said second work site and said first work site;
means for applying said at least one operation performed at said second work site to said first project data file at said first work site; and,
means for producing a finished work product at said first work site without means for copying said second data file to said first work site.

22. The system of claim 21 further comprising:
means for providing feedback to a second worker at said second work site from a first worker at said first work site.

23. The system of claim 22 wherein said means for providing feedback comprises a real-time communications link.

24. The system of claim 22 wherein said means for providing feedback comprises a non-real-time communications link.

25. The system of claim 21 further comprising:
means for copying said at least one operation between said second work site and a third work site for redundant configuration management.

26. The system of claim 21 wherein said means for copying said at least one operation comprises a real-time communications link.

27. The system of claim 21 wherein said means for copying said at least one operation comprises a non-real-time communications link.

28. The system of claim 21 wherein said means for applying said at least one operation comprises a stamp associated with said at least one operation.

29. The system of claim 28 wherein said means for applying said at least one operation further comprises a first operation having a first stamp from said first work site and a second operation having a second stamp from said second work site and means for applying said first operation and said second operation to said first project data file at said first work site in an order based on said first stamp and said second stamp.

30. The system of claim 29 further comprising:
means for detecting a collision resulting from the application of said first operation and said second operation to a first portion of said first project data file.

31. The system of claim 21 further comprising:
means for generating metrics based on said at least one operation itself.

32. The system of claim 21 further comprising:
means for generating metrics based on an intermediate work piece produced by applying said at least one operation to said first project data file.

33. The system of claim 21 further wherein said means for copying said first data project file further comprises physical transfer of said first data project file to said second work site and wherein said means for copying said at least one operation further comprises electronic transfer.

34. A system for performing distributed computer projects using labor outsourcing comprising:
means for copying a first project data file from a first work site to a second project data file at a second work site;
means for copying said first project data file from said first work site to a third project data file at a third work site;
means for performing a third at least one operation at said third work site on said third project data file;
means for copying said third at least one operation from said third work site to said second work site;
means for performing said third at least one operation at said second work site on said second project data file;
means for performing a second at least one operation at said second work site on said second project data file;
means for copying said third at least one operation and said second at least one operation from said second work site to said first work site;
means for applying said at third least one operation performed at said third work site and said second at least one operation performed at said second work site to said first project data file at said first work site; and,
means for producing a finished work product at said first work site without copying said third data project file or said second data project file to said first work site.

35. The system of claim 34 further comprising:
means for generating metrics based on said second at least one operation itself.

36. The system of claim 34 further comprising:
means for generating metrics based on an intermediate work piece produced by applying said at second least one operation to said first project data file.

37. The system of claim 34 further comprising:
means for generating metrics based on said third at least one operation itself.

38. The system of claim 34 further comprising:
means for generating metrics based on an intermediate work piece produced by applying said at third least one operation to said first project data file.
